(19) United States
(12) Patent Application Publication
(10) Pub. No.: US 2018/0179794 A1
(43) Pub. Date: Jun. 28, 2018

(54) SECURITY LATCH FOR SASHES

(71) Applicant: Qualtech System Inc., Naperville, IL (US)

(72) Inventors: WEN WU, Naperville, IL (US); HUA WU, TIANJIN CITY (CN)

(21) Appl. No.: 15/390,425

(22) Filed: Dec. 23, 2016

(51) Int. Cl. E05C 3/14

(52) U.S. Cl. CPC E05C 3/14

(57) ABSTRACT

A security latch for sashes comprises a shell body, a moving piece, an axle and a resilient assembly. An accommodating cavity is formed inside the shell body and opened at a flat side of the shell body, and a first concave surface is formed at a bottom of the accommodating cavity away from the flat side. The moving piece is received in the accommodating cavity and is rotatable around the axle installed in the accommodating cavity. The moving piece comprises an engaging face formed at a side thereof and a second concave surface formed at another side thereof. The resilient assembly is disposed between the first concave surface and the second concave surface to resiliently and movably engage with the first and second concave surfaces. The engaging face emerges out of the accommodating cavity from the flat side for blocking any movement along the flat side.

### BACKGROUND OF THE INVENTION

### 1. Field of the Invention

The present invention relates to a security latch for sashes. Particularly, a security latch for sashes comprises parts having a prolonged working life and being easily installed.

### 2. The Related Arts

Security locks are usually required for sash windows for security reasons. Usually a spring is used in the security locks for easy operation of locking or unlocking the security locks. Particularly, when a tumbler of the security locks is pushed to unlock the security locks, the spring helps to restore the tumbler back to its original position of locking of the security locks. In a lot of prior designs of the security locks, twisting and bending of the spring are always required to perform the above locking/unlocking mechanism of the security locks. As a result, the spring usually cannot survive for a reasonably working time since twisting and bending are always a heavy burden to material of the spring. Besides, most prior designs require more than two contact points for the spring in the security locks to work. Hence, the spring made by very strong material is critical all the time for the security locks of the prior designs to work.

Meanwhile, due to requirement of the spring in the security locks, installation of the spring in the security locks is always complicated. Particularly, at least two ends of the spring should be fixed in the security locks for the spring to work. Additional contact points of the spring other than two ends of the spring will be in need of more fixing parts designed in the security locks to fix the spring for working. Hence, installation of the spring will not be easy if fixture of the spring is complicated.

Hence, an inventive design to overcome the above shortcomings of the prior designs of the security locks is considered to be important for providing a superior security latch having a prolonged working life and a cheap manufacturing cost due to convenient installation.

### BRIEF DESCRIPTION OF THE DRAWINGS

The present invention will become more readily apparent to those ordinarily skilled in the art after reviewing the following detailed description and accompanying drawings, in which:

FIG. 1 shows a schematic exploded perspective view of a security latch for sashes in accordance with a preferred embodiment of the present invention.

FIG. 2 shows a schematic assembly perspective view of the security latch for sashes as shown in FIG. 1 in accordance with a preferred embodiment of the present invention.

FIG. 3 shows a schematic assembled perspective view of the security latch for sashes as shown in FIG. 2 with a moving piece thereof retracted in a shell body thereof in accordance with a preferred embodiment of the present invention.

FIG. 4 shows a schematic sectional view of the security latch for sashes as shown in FIG. 2 in a first status thereof in accordance with a preferred embodiment of the present invention.

FIG. 5 shows a schematic sectional view of the security latch for sashes as shown in FIG. 2 in a second status thereof in accordance with a preferred embodiment of the present invention.

FIG. 6 shows a schematic sectional view of the security latch for sashes as shown in FIG. 2 in a third status thereof in accordance with a preferred embodiment of the present invention.

FIG. 7 shows a schematic sectional view of the security latch for sashes as shown in FIG. 4 showing an installed relationship between the security latch and a sash and a working relationship between the security latch and a window frame in accordance with a preferred embodiment of the present invention.

### DETAILED DESCRIPTION OF PREFERRED EMBODIMENT

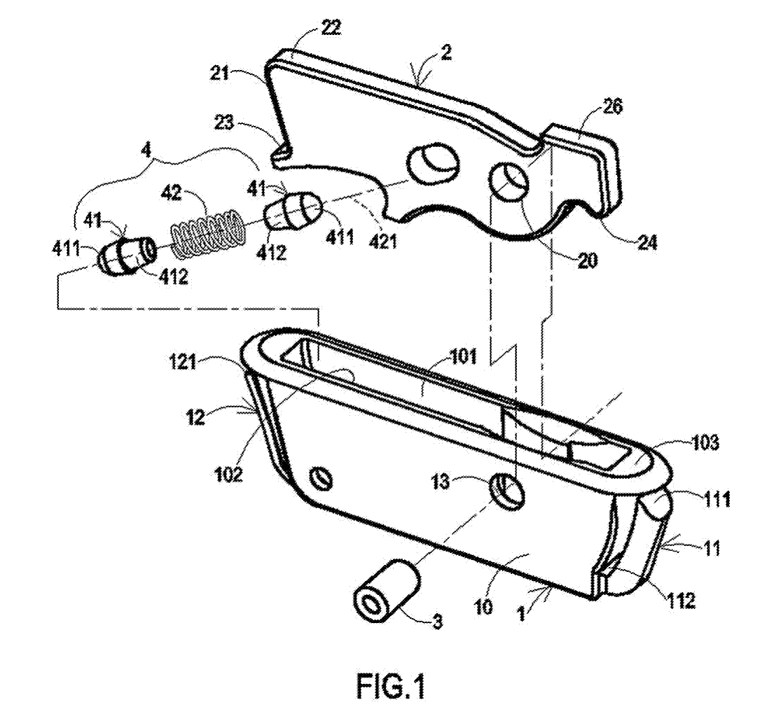

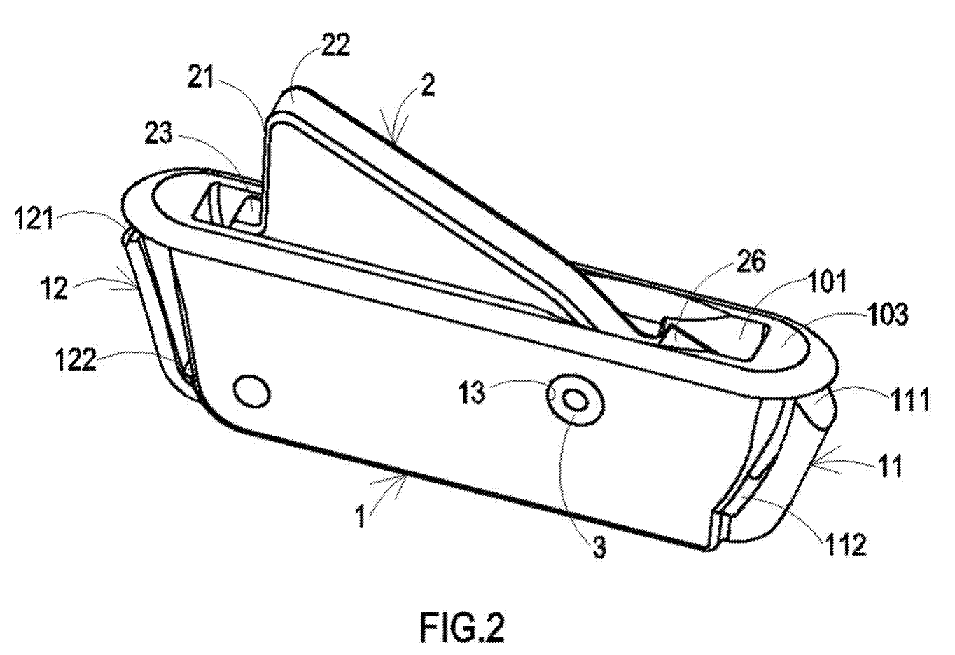

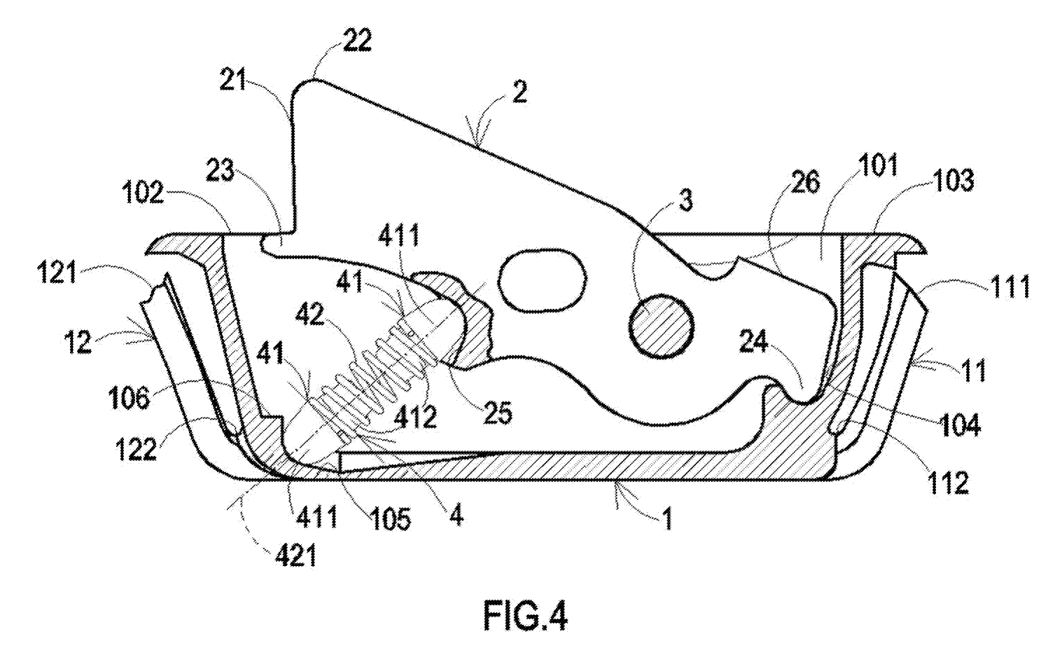

With reference to FIG. 1 and FIG. 2, a security latch for sashes in accordance with a preferred embodiment of the present invention comprises a shell body 1, a moving piece 2, an axle 3 and a resilient assembly 4. The shell body 1 comprises a hollow main body 10 containing an accommodating cavity 101 formed therein. An opening 102 is formed at a flat side 103 of the main body 10 so as to expose the accommodating cavity 101 to an outside environment of the main body 10. A hole 13 is formed at each of two opposite sides of the main body 10 adjacent to the flat side 103 of the main body 10 to penetrate through the each of the two opposite sides of the main body 10. The two holes 13 of the two opposite sides of the main body 10 are coaxially corresponded to each other. Further referring to FIG. 1 and FIG. 4, a recess 104 is formed at a corner of a bottom of the accommodating cavity 101. A step 106 is formed at another corner of the bottom of the accommodating cavity 101. A smooth first concave surface 105 is formed at the bottom of the accommodating cavity 101 next to the step 106. In a preferred embodiment of the present invention, the first concave surface 105 is in a form of a columnar concave surface. A first arm 11 extends from an outer side of the main body 10 and retains to extend roughly along the outer side of the main body 10 and to be mostly spaced from the outer side of the main body 10. The first arm 11 is shaped to become slimmer from a connection of the first arm 11 with the main body 10 to a distal end of the first arm 11. A first latching end 111 is formed at the distal end of the first arm 11 and has at least two steps formed thereon. A first rib 112 is integrally formed beside the connection of the first arm 11 with the main body 10 to strengthen the connection of the first arm 11. A second arm 12 extends from another outer side of the main body 10 opposite to the first arm 11. The second arm 12 extends roughly along the another outer side of the main body 10 and is mostly spaced from the another outer side of the main body 10. The second arm 12 is shaped to become slimmer from a connection of the second arm 12 with the main body 10 to a distal end of the second arm 12. A second latching end 121 is formed at the distal end of the second arm 12 and has at least two steps formed thereon. A second rib 122 is integrally formed beside the connection of the second arm 12 with the main body 10 to strengthen the connection of the second arm 12. The first and second arms 11, 12 are respectively able to generate a resistant resilient force to move back to their original design positions when either one of the first and second arms 11, 12 is pushed toward the main body 10. In a preferred embodiment of the present invention, the first arm 11 is sized larger than the second arm 12. Furthermore, in a preferred embodiment of the present invention, only one of the first and second latching ends 111, 121 has at least two steps formed thereon while the other of the first and second latching ends 111, 121 has a simple flat end face thereon.

With reference to FIG. 1 and FIG. 4, the moving piece 2 of the security latch for sashes is in a form of a block. A hole 20 is formed at the moving piece 2 to penetrate through the moving piece 2. An engaging face 21 in a form of a flat surface is formed at a side of the moving piece 2. A round corner 22 having a smooth convex surface is formed at one side of the engaging face 21 of the moving piece 2. A stopper 23 in a form of a bulge is formed at another side of the engaging face 21 opposite to the round corner 22. A protrusion 24 with a semi-columnar surface is formed at another side of the moving piece 2 opposite to the engaging face 21 so that the engaging face 21 and the protrusion 24 are respectively located at two opposite sides of the hole 20. A smooth second concave surface 25 is formed at a side of the moving piece 2 between the stopper 23 and the protrusion 24, and faces correspondingly toward the first concave surface 105 of the shell body 1 when the moving piece 2 is installed within the shell body 1. In a preferred embodiment of the present invention, the second concave surface 25 is in a form of a columnar concave surface. A pushing face 26 is disposed at another side of the moving piece 2 opposite to the second concave surface 25. The pushing face 26 is in a form of a flat surface, and is substantially flush with the flat side 103 of the shell body 1 when the moving piece 2 is completely received in the accommodating cavity 101 of the main body 10 of the shell body 1.

The axle 3 is in a form of a column and is installed to the shell body 1 and the moving piece 2 by extending firstly through one of the two holes 13 of the main body 10, through the hole 20 of the moving piece 2 and finally through the other of the two holes 13 of the main body 10. Two ends of the axle 3 are respectively fixedly engaged in the two holes 13 of the main body 10. A diameter of the hole 20 of the moving piece 2 is larger than an outer diameter of the axle 3 so that the moving piece 2 is able to freely move and rotate around the axle 3.

With reference to FIG. 1 and FIG. 4, the resilient assembly 4 of the security latch for sashes in accordance with a preferred embodiment of the present invention comprises two seats 41 and a columnar spiral spring 42. One of the two seats 41 is disposed at one end of the spring 42 while the other of the two seats 41 is disposed at the other end of the spring 42. Each of the two seats 41 comprises a head 411 and a pole 412. The head 411 is hemispherical, and the pole 412 is columnar. A diameter of the head 411 is larger than a diameter of the spring 42, and the diameter of the spring 42 is larger than a diameter of the pole 412. The each of the two seats 41 is disposed at a corresponding end of the spring 42 by using the pole 412 inserted into the corresponding end of the spring 42 and the head 411 staying outside to engage against the corresponding end of the spring 42.

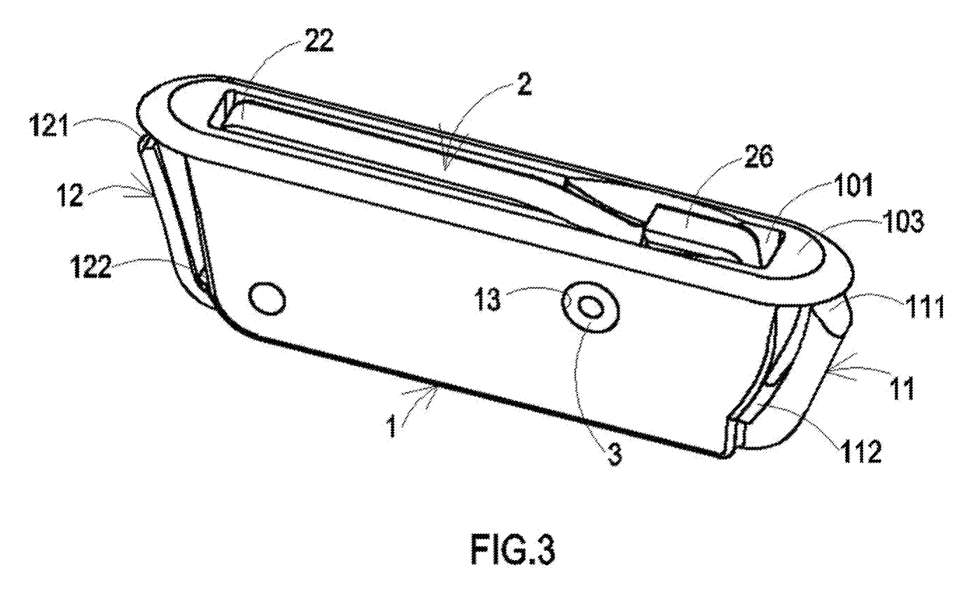

With reference to FIGS. 1 to 4, for assembly, the resilient assembly 4 is firstly placed in the accommodating cavity 101 of the main body 10 of the shell body 1. The one of the two seats 41 of the resilient assembly 4 rests on the first concave surface 105 of the main body 10 at the bottom of the accommodating cavity 101. The moving piece 2 is then installed within the accommodating cavity 101 of the main body 10 of the shell body 1 by inserting at least a half of the moving piece 2 into the accommodating cavity 101 via the opening 102 on the flat side 103 of the main body 10. The hole 20 of the moving piece 2 is correspondingly and coaxially aligned with the holes 13 of the main body 10 after insertion of the moving piece 2 into the accommodating cavity 101 in order for installation of the axle 3. The axle 3 is installed in the shell body 1 by extending firstly through one of the two holes 13 of the main body 10, through the hole 20 of the moving piece 2 and finally through the other of the two holes 13 of the main body 10 sequentially. The axle 3 is then fixedly engaged in the two holes 13 of the main body 10 respectively due to a larger size of a corresponding end of the axle 3 than a hole size of each of the two holes 13 of the main body 10. Since the diameter of the hole 20 of the moving piece 2 is larger than the outer diameter of the axle 3, the moving piece 2 is able to freely move and rotate around the axle 3. After installation of the moving piece 2, the other of the two seats 41 of the resilient assembly 4 is abutted against the second concave surface 25 of the moving piece 2 so that the spring 42 is able to resiliently function between the first and second concave surfaces 105, 25 based on locations of the moving piece 2 in the accommodating cavity 101 of the main body 10. Without any external compression force applied upon the spring 42, the moving piece 2 strides right on the resilient assembly 4 and the axle 3, and at least the engaging face 21 and the round corner 22 of the moving piece 2 are exposed outside the accommodating cavity 101 of the shell body 1. The protrusion 24 of the moving piece 2 is inserted and placed in the recess 104 of the main body 10 to stop further extending of the engaging face 21 out of the accommodating cavity 101 and rotation of the moving piece 2 around the axle 3 when the resilient assembly 4 resiliently functions between the first and second concave surfaces 105, 25, and the resilient assembly 4 is located at the side of the axle 3 opposite to the protrusion 24. If any, a spring force of the spring 42 is applied to generate a clockwise torque for rotation of the moving piece 2 while a counterforce against the spring force due to engagement between the protrusion 24 and the recess 104 is applied to generate a counterclockwise torque against the clockwise torque of the spring 42. At this moment, the engaging face 21 is substantially perpendicular to the flat side 103 of the shell body 1. In the meantime, a side of the stopper 23 of the moving piece 2 is substantially flush with the flat face 103 of the shell body 1 while the stopper 23 is entirely located in the accommodating cavity 101 of the shell body 1.

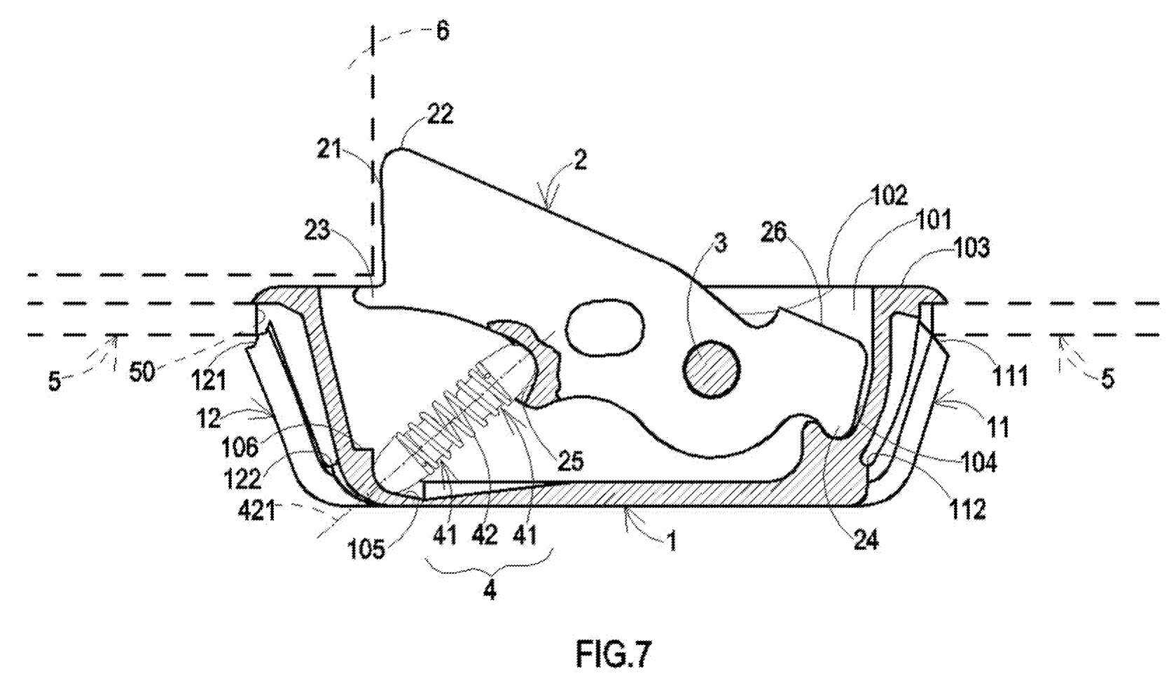

With reference to FIG. 4 and FIG. 7, in use, the security latch in accordance with a preferred embodiment of the present invention is installed at a preset slot 51 of a sash 5 for a window or a door, especially for example, a sash window. The security latch is directly pushed to be inserted into the slot 51 of the sash 5 until the flat side 103 of the shell body 1 is substantially flush with an outer face of the sash 5. During installation of the security latch, the first arm 11 and the second arm 12 extending beside the main body 10 of the shell body 1 are respectively engaged with two opposite ends of the slot 51 and move to pass through the outer face of the sash 5 from connections of the first and second arms 11, 12 with the main body 10 toward distal ends of the first and second arms 11, 12. After the entire first and second arms 11, 12 respectively pass through the outer face of the sash 5 together with the main body 10, an end edge of each of two opposite ends of the slot 51 is fixedly snapped by and located between an edge flange of the flat side 103 of the main body 10 and a corresponding one of the first latching end 111 of the first arm 11 and the second latching end 121 of the second arm 12. Since the first latching end 111 of the first arm 11 and the second latching end 121 of the second arm 12 respectively have at least two steps formed thereon, the first and second arms 11, 12 are able to fit with various sizes of the slot 51 and various thicknesses of the end edge of the each end of the slot 51 by using different steps of the first latching end 111 and the second latching end 121 to fixedly snap and engage with the corresponding end edge of the each end of the slot 51. The engaging face 21 and the round corner 22 of the moving piece 2 are exposed outside the accommodating cavity 101 of the shell body 1 due to resilient support of the resilient assembly 4, and the moving piece 2 is blocked for further movement or rotation by the protrusion 24 thereof engaging in the recess 104 of the main body 10 of the shell body 1.

As shown in FIG. 4, in a first working status of the security latch in accordance with a preferred embodiment of the present invention, the engaging face 21 and the round corner 22 of the moving piece 2 are both exposed outside the shell body 1 due to the resilient support of the spring 42 of the resilient assembly 4. A window frame 6 moving toward the security latch along the outer face of the sash 5 is about to be blocked by the engaging face 21 of the moving piece 2 for further movement thereof since the engaging face 21 of the moving piece 2 extends out of the flat side 103 of the shell body 1 and the outer face of the sash 5. The protrusion 24 of the moving piece 2 is placed and engaged in the recess 104 of the main body 10 of the shell body 1 at the same time. Engagement between the protrusion 24 and the recess 104 is able to generate a counterforce or a counterclockwise torque against any impact force or clockwise torque from the window frame 6 upon the engaging face 21 of the moving piece 2 since an applying direction of the impact force from the window frame 6 is opposite to the counterforce from the engagement between the protrusion 24 and the recess 104 in view of rotation of the moving piece 2 around the axle 3. Furthermore, due to applying of the spring 42 between the first and second concave surfaces 105, 25, a virtual central longitudinal axis 421 of the spring 42 is collinear with a virtual connecting line between a curvature center of the first concave surface 105 and a curvature center of the second concave surface 25. The longitudinal axis 421 of the spring 42 is also collinear with a virtual line connected between an engaging point of the one of the two seats 41 and the first concave surface 105, and an engaging point of the other of the two seats 41 and the second concave surface 25 due to the resilient support of the resilient assembly 4 and shapes of the heads 41 and the first and second concave surfaces 105, 25. Usually, the engaging point of the one of the two seats 41 and the first concave surface 105 is a farthest surface point of the first concave surface 105 away from the second concave surface 25 along the longitudinal axis 421 of the spring 42. The engaging point of the other of the two seats 41 and the second concave surface 25 is a farthest surface point of the second concave surface 25 away from the first concave surface 105 along the longitudinal axis 421 of the spring 42.

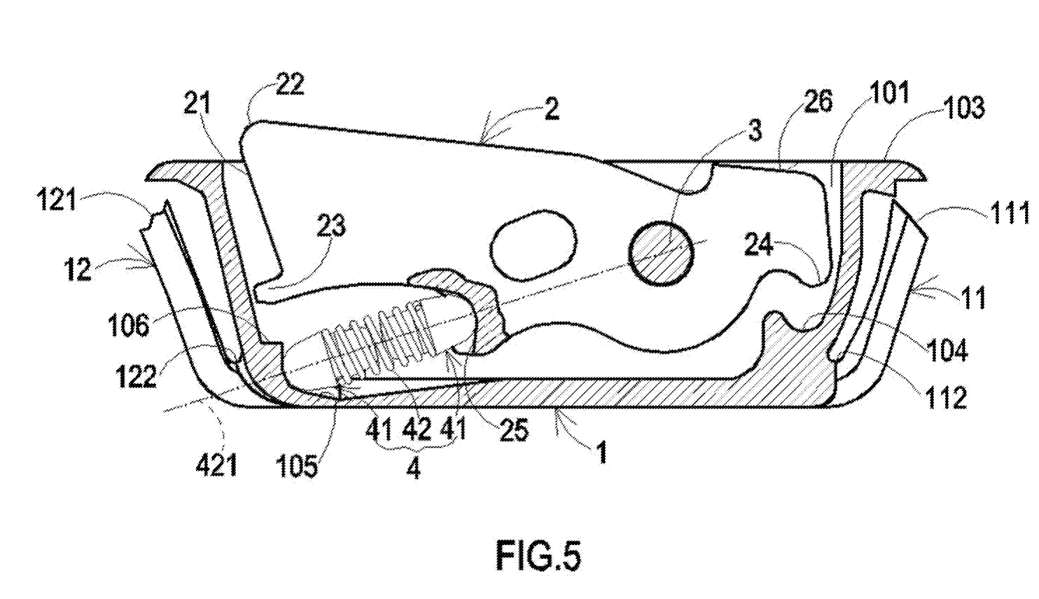

When the further movement of the window frame 6 depicted above is considered to apply, an external force from users is able to be applied on the round corner 22 of the moving piece 2 to push the engaging face 21 of the moving piece 2 into the accommodating cavity 101 of the shell body 1 and to rotate the moving piece 2 counterclockwise. As shown in FIG. 5, in a second working status of the security latch in accordance with a preferred embodiment of the present invention, the engaging face 21 of the moving piece 2 is pushed halfway into the accommodating cavity 101 of the shell body 1. The spring 42 of the resilient assembly 4 is compressed further to generate an additional resistant spring force applied on the two seats 41 of the resilient assembly 4, respectively. The two seats 41 of the resilient assembly 4 are respectively forced by the resistant spring force of the spring 42 to automatically and simultaneously move along the first and second concave surfaces 105, 25 due to movement of the moving piece 2 by the external force from users. In the meantime, the protrusion 24 of the moving piece 2 is moved away from the recess 104 of the main body 1 because of rotation of the moving piece 2 around the axle 3. In a preferred embodiment of the present invention as shown in FIG. 5 for the second working status of the security latch in accordance with the present invention, the axle 3 is right located at a virtual extension line of the longitudinal axis 421 of the spring 42. At this moment, the spring 42 is compressed to its shortest length in order to provide the largest resistant spring force without generating any rotational torque to rotate the moving piece 2. The moving piece 2 is situated in a verge of all forces applied thereon being balanced with one another, including the external force from users and the spring force of the spring 42. The longitudinal axis 421 of the spring 42 is still collinear with the connecting line between the curvature center of the first concave surface 105 and the curvature center of the second concave surface 25, and collinear with the line connected between the engaging point of the one of the two seats 41 and the first concave surface 105, and the engaging point of the other of the two seats 41 and the second concave surface 25.

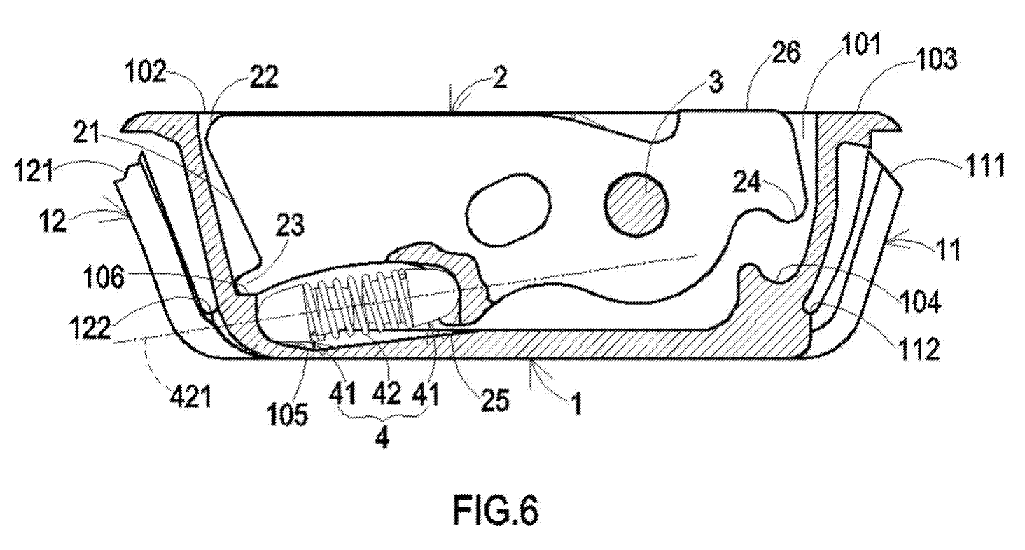

Further applying the external force from users upon the round corner 22 of the moving piece 2 is able to move and rotate the moving piece 2 further. As shown in FIG. 6, in a third working status of the security latch in accordance with a preferred embodiment of the present invention, the moving piece 2 moves and rotates around the axle 3 by passing the verge thereof as depicted above, and the longitudinal axis 421 of the spring 42 is moved to a different side of the axle 3 same as the protrusion 24 and opposite to an original location of the longitudinal axis 421 of the spring 42 as depicted in the first working status of the security latch. At this moment, any spring force of the spring 42 is applied to generate a counterclockwise torque for rotation of the moving piece 2, instead of the above depicted clockwise torque generated in the first working status of the security latch. In response to urge of the spring force and its generated counterclockwise torque of the spring 42, the moving piece 2 rotates counterclockwise automatically without further applying of the external force from users until the entire moving piece 2 is extracted and plunged in the accommodating cavity 101 of the shell body 1. In the meantime, the stopper 23 of the moving piece 2 is designed to rest and engage with the step of the main body 10 of the shell body 1 to stop further rotation of the moving piece 2 at the same time when the moving piece 2 is completely extracted and plunged in the accommodating cavity 101 of the shell body 1 without any portion of the moving piece 2 emerging out of the accommodating cavity 101 of the shell body 1. In the meantime, the pushing face 26 of the moving piece 2 is moved to be flush with the flat side 103 of the shell body 1 to avoid forming any block beyond the flat side 103 of the shell body 1. Once the engaging face 21 of the moving piece 2 is removed out of a moving path of the window frame 6, as imaginable based on disclosure of FIG. 7, the window frame 6 is able to move further along the outer face of the sash 5 and pass across the security latch of the present invention for wider opening of the window or door.

The moving piece 2 of the security latch in accordance with the present invention is able to restore its original designed position as shown in FIG. 4 from the above depicted position as shown in FIG. 6 by simply applying a pushing force from users onto the pushing face 26 of the moving piece 2. Once the longitudinal axis 421 of the spring 42 is moved to the side of the axle 3 opposite to the protrusion 24, the moving piece 2 is able to rotate clockwise automatically without further applying of the pushing force from users on the pushing face 26 due to urge of the spring force and its generated clockwise torque of the spring 42 until the entire engaging face 21 of the moving piece 2 emerges out of the accommodating cavity 101 of the shell body 1, and the protrusion 24 of the moving piece 2 rests and is engaged with the recess 104 of the shell body 1, as explicitly shown in FIG. 4.

The security latch in accordance with the present invention is superior in many ways. First of all, the longitudinal axis 421 of the spring 42 is always collinear with the connecting line between the curvature center of the first concave surface 105 and the curvature center of the second concave surface 25, and collinear with the line connected between the engaging point of the one of the two seats 41 and the first concave surface 105, and the engaging point of the other of the two seats 41 and the second concave surface 25, no matter the security latch of the present invention is in the first, second or third working status thereof. The above depicted particular design of the resilient assembly 4 assures the spring 42 is only designed to bear a simple linear external force for compression of the spring 42 rather than any other kind of complicated deflections. As a result, a working life of the spring 42 can be elongated, and unexpected damage to the spring 42 can be easily avoided since no complicated deflection is able to be applied on the spring 42 for such undesired damage.

Secondly, the moving piece 2 of the security latch in accordance with the present invention is able to automatically rotate via a properly generated spring force and its corresponding torque of the spring 42 during a process from the second working status of the security latch to the third working status of the security latch, or during a process from the second working status of the security latch back to the first working status of the security latch. In other words, as long as the longitudinal axis 421 of the spring 42 is moved to pass across the axle 3, the spring 42 is designed to provide the required forces and/or torques to independently cause further movement or rotation of the moving piece 2 to its final desired positions, i.e., the position of the moving piece 2 as shown in FIG. 4 or the position of the moving piece 2 as shown in FIG. 6. Such superior design of the resilient assembly 4 assures precise movement and rotation of the moving piece 2 to its final desired positions without any mistaken force from users causing unnecessary excess movement of the moving piece 2, and also assures the elongated life of the spring 42 since less external force is required to be applied thereon.

In addition, the security latch in accordance with the present invention is also beneficial in view of designs of the first and second arms 11, 12. The first and second arms 11, 12 are much strong for installation of the security latch to the sash 5 since the ribs 112, 122 of the first and second arms 11, 12 respectively strengthen the connections of the first and second arms 11, 12 with the main body 10 of the shell body 1. Designs of the thinker connections with the main body 10 and slimmer distal ends of the first and second arms 11, 12 also contribute to provide a stronger structure for either the first arm 11 or the second arm 12 to resist any overwhelming external force during installation of the security latch. Besides, the unsymmetrical design for the first and second arms 11, 12, i.e., the first arm 11 is sized larger than the second arm 12, is useful to smoothly fit the security latch of the present invention for the slot 51 of the sash 5 when a slot length of the slot 51 is relatively larger than a total longitudinal length of the main body 10 of the shell body 1. The larger-sized first arm 11 is able to provide a stronger resilient force than the second arm 12 during installation of the security latch so that the security latch of the present invention can be installed in the slot 51 directly without any additional position adjustment along a slot-length direction defined by the slot 51.

Although only the preferred embodiments of the present invention are described as above, the practicing claim scope of the present invention is not limited to the disclosed embodiments. It is understood that any simple equivalent changes, adjustments or modifications to the present invention based on the following claims of the present invention and the content of the above invention description may be still covered within the claimed scope of the following claims of the present invention.

What is claimed is:

1. A security latch for sashes, comprising:
a shell body comprising a flat side, an accommodating cavity formed inside the shell body and opened at the flat side to communicate with an outside of the shell body, a first concave surface formed at a bottom of the accommodating cavity away from the flat side;
a moving piece received in the accommodating cavity and comprising an engaging face formed at a side of the moving piece, the moving piece capable of allowing the engaging face emerging out of the accommodating cavity from the flat side for blocking any movement along the flat side of the shell body, a second concave surface formed at another side of the moving piece to face toward the first concave surface of the shell body when the moving piece is received in the accommodating cavity;
an axle installed at the shell body to penetrate through the moving piece so as to allow the moving piece being movable and rotatable around the axle in the accommodating cavity, the moving piece rotating around the axle from a first position of the moving piece where the engaging face of the moving piece emerges outside the flat side of the shell body for blocking to a second position of the moving piece where the engaging face of the moving piece is retracted back in the accommodating cavity of the shell body; and
a resilient assembly comprising two seats each of which is disposed at one of two distal ends of the resilient assembly, the resilient assembly defining a virtual central longitudinal axis to respectively pass through the two seats, the resilient assembly disposed between the first concave surface of the shell body and the second concave surface of the moving piece to resiliently and movably engage with the first and second concave surfaces via the two seats of the resilient assembly, respectively, the longitudinal axis of the resilient assembly being collinear with a virtual line defined to be connected between an engaging point of one of the two seats and the first concave surface, and an engaging point of the other of the two seats and the second concave surface when the two seats of the resilient assembly respectively move along and engage with the first and second concave surfaces due to movement of the moving piece around the axle between the first and second positions thereof in the accommodating cavity of the shell body.

2. The security latch for sashes as claimed in claim 1, wherein each of the two seats of the resilient assembly comprises a hemispherical head to move along and engage with a corresponding one of the first and second concave surfaces.

3. The security latch for sashes as claimed in claim 2, wherein a spiral spring is disposed between the two seats of the resilient assembly, a pole extending from the head of the each of the two seats is inserted and restrainedly stays in an inner space of the spiral spring.

4. The security latch for sashes as claimed in claim 1, wherein a stopper is formed at a side of the engaging face of the moving piece, and a step is formed at the bottom of the accommodating cavity next to the first concave surface, the stopper is engaged with the step to stop further movement of the moving piece when the moving piece moves from the first position thereof to the second position thereof and is located in the second position thereof.

5. The security latch for sashes as claimed in claim 4, wherein the stopper moves to the flat side of the shell body, and a side of the stopper is flush with the flat face of the shell body and the stopper is entirely located in the accommodating cavity of the shell body when the moving piece moves from the second position thereof to the first position thereof and is located in the first position thereof.

6. The security latch for sashes as claimed in claim 1, wherein a protrusion is formed at another side of the moving piece opposite to the engaging face, and a recess is formed at a corner of the bottom of the accommodating cavity different from the first concave surface, the protrusion is engaged with and stays in the recess to stop further movement of the moving piece when the moving piece moves from the second position thereof to the first position thereof and is located in the first position thereof.

7. The security latch for sashes as claimed in claim 1, wherein a first arm and a second arm respectively extend from and along two opposite outer sides of the shell body, and are respectively spaced mostly from the outer sides of the shell body for installation of the security latch to a sash.

8. A security latch for sashes, comprising:
a shell body comprising a flat side, an accommodating cavity formed inside the shell body and opened at the flat side to communicate with an outside of the shell body, a first concave surface formed at a bottom of the accommodating cavity away from the flat side;
a moving piece received in the accommodating cavity, and being movable and rotatable around an axle installed at the shell body in the accommodating cavity, the moving piece comprising an engaging face formed at a side of the moving piece, the moving piece capable of allowing the engaging face emerging out of the accommodating cavity from the flat side for blocking any movement along the flat side of the shell body, a second concave surface formed at another side of the moving piece to face toward the first concave surface of the shell body when the moving piece is movably received in the accommodating cavity, the moving piece rotating around the axle from a first position of the moving piece where the engaging face of the moving piece emerges outside the flat side of the shell body for blocking to a second position of the moving piece where the engaging face of the moving piece is retracted back in the accommodating cavity of the shell body; and
a resilient assembly defining a virtual central longitudinal axis to extend along the resilient assembly, the resilient assembly disposed between the first concave surface of the shell body and the second concave surface of the moving piece to resiliently and movably engage with the first and second concave surfaces, respectively, the longitudinal axis of the resilient assembly being collinear with a virtual connecting line between a curvature center of the first concave surface of the shell body and a curvature center of the second concave surface of the moving piece when the resilient assembly respectively moves along and engages with the first and second concave surfaces due to movement of the moving piece around the axle between the first and second positions thereof in the accommodating cavity of the shell body.

9. A security latch for sashes, comprising:
a shell body comprising a flat side, an accommodating cavity formed inside the shell body and opened at the flat side to communicate with an outside of the shell body, a first concave surface formed at a bottom of the accommodating cavity away from the flat side;
a moving piece received in the accommodating cavity and comprising an engaging face formed at a side of the moving piece, the moving piece capable of allowing the engaging face emerging out of the accommodating cavity from the flat side for blocking any movement along the flat side of the shell body, a second concave surface formed at another side of the moving piece to face toward the first concave surface of the shell body when the moving piece is received in the accommodating cavity;
an axle installed at the shell body in the accommodating cavity so as to allow the moving piece being movable and rotatable around the axle in the accommodating cavity, the moving piece rotating around the axle from a first position of the moving piece where the engaging face of the moving piece emerges outside the flat side of the shell body for blocking to a second position of the moving piece where the engaging face of the moving piece is retracted back in the accommodating cavity of the shell body; and
a resilient assembly defining a virtual central longitudinal axis extending longitudinally through the resilient assembly, the resilient assembly disposed between the first concave surface of the shell body and the second concave surface of the moving piece to resiliently and movably engage with the first and second concave surfaces, respectively, wherein a third position of the moving piece is defined where the axle is located at a virtual extension line of the longitudinal axis of the resilient assembly, the resilient assembly generates a resistant spring force against an external force applied on the moving piece when the moving piece moves from the first position to the third position, or from the second position to the third position, and releases the resistant spring force to drive the moving piece moving when the moving piece rotates from the third position to either one of the first and second positions.

10. The security latch for sashes as claimed in claim 9, wherein the resilient assembly comprises two seats, each of the two seats is disposed at one of two distal ends of the resilient assembly, and comprises a head to move along and engage with a corresponding one of the first and second concave surfaces.

11. The security latch for sashes as claimed in claim 10, wherein a spiral spring is disposed between the two seats of the resilient assembly, a pole extending from the head of the each of the two seats is inserted and restrainedly stays in an inner space of the spiral spring.

12. The security latch for sashes as claimed in claim 9, wherein a stopper is formed at a side of the engaging face of the moving piece, and a step is formed at the bottom of the accommodating cavity next to the first concave surface, the stopper is engaged with the step to stop further movement of the moving piece when the moving piece moves from the first position thereof to the second position thereof and is located in the second position thereof.

13. The security latch for sashes as claimed in claim 12, wherein the stopper moves to the flat side of the shell body, and a side of the stopper is flush with the flat face of the shell body and the stopper is entirely located in the accommodating cavity of the shell body when the moving piece moves from the second position thereof to the first position thereof and is located in the first position thereof.

14. The security latch for sashes as claimed in claim 9, wherein a protrusion is formed at another side of the moving piece opposite to the engaging face, and a recess is formed at a corner of the bottom of the accommodating cavity different from the first concave surface, the protrusion is engaged with and stays in the recess to stop further movement of the moving piece when the moving piece moves from the second position thereof to the first position thereof and is located in the first position thereof.

15. The security latch for sashes as claimed in claim 9, wherein a first arm and a second arm respectively extend from and along two opposite outer sides of the shell body, and are respectively spaced mostly from the outer sides of the shell body for installation of the security latch to a sash.

16. A security latch for sashes, comprising:
a shell body comprising a flat side, an accommodating cavity formed inside the shell body and opened at the flat side to communicate with an outside of the shell body, a first concave surface formed at a bottom of the accommodating cavity away from the flat side;
a moving piece received in the accommodating cavity, and being movable and rotatable around an axle installed at the shell body in the accommodating cavity, the moving piece comprising an engaging face formed at a side of the moving piece, the moving piece capable of allowing the engaging face emerging out of the accommodating cavity from the flat side for blocking any movement along the flat side of the shell body, a second concave surface formed at another side of the moving piece to face toward the first concave surface of the shell body when the moving piece is movably received in the accommodating cavity, the moving piece rotating around the axle from a first position of the moving piece where the engaging face of the moving piece emerges outside the flat side of the shell body for blocking to a second position of the moving piece where the engaging face of the moving piece is retracted back in the accommodating cavity of the shell body; and
a resilient assembly disposed between the first concave surface of the shell body and the second concave surface of the moving piece to resiliently and movably engage with the first and second concave surfaces, respectively, the resilient assembly defining a virtual central longitudinal axis extending longitudinally through the resilient assembly, and comprising two seats each of which is disposed at one of two distal ends of the resilient assembly, wherein the each of the two seats maintains movement thereof along the longitudinal axis of the resilient assembly when the resilient assembly moves between the first concave surface of the shell body and the second concave surface of the moving piece due to rotation of the moving piece around the axle between the first and second positions of the moving piece.

17. The security latch for sashes as claimed in claim 16, wherein a spiral spring is disposed between the two seats of the resilient assembly, the each of the two seats comprises a head to move along and engage with a corresponding one of the first and second concave surfaces, a pole extending from the head of the each of the two seats is inserted and restrainedly stays in an inner space of the spiral spring.

18. The security latch for sashes as claimed in claim 16, wherein a stopper is formed at a side of the engaging face of the moving piece, and a step is formed at the bottom of the accommodating cavity next to the first concave surface, the stopper is engaged with the step to stop further movement of the moving piece when the moving piece moves from the first position thereof to the second position thereof and is located in the second position thereof.

19. The security latch for sashes as claimed in claim 16, wherein a protrusion is formed at another side of the moving piece opposite to the engaging face, and a recess is formed at a corner of the bottom of the accommodating cavity different from the first concave surface, the protrusion is engaged with and stays in the recess to stop further movement of the moving piece when the moving piece moves from the second position thereof to the first position thereof and is located in the first position thereof.

20. The security latch for sashes as claimed in claim 16, wherein a first arm and a second arm respectively extend from and along two opposite outer sides of the shell body, and are respectively spaced mostly from the outer sides of the shell body for installation of the security latch to a sash.
